(19) United States
(12) Patent Application Publication
(10) Pub. No.: US 2024/0426624 A1
(43) Pub. Date: Dec. 26, 2024

(54) METHOD FOR DETECTING A BOUNDARY OF A TRAFFIC LANE

(71) Applicants: AMPERE S.A.S., Boulogne Billancourt (FR); CNRS, Paris (FR); UNIVERSITE DE TECHNOLOGIE DE COMPIEGNE (UTC), Compiègne (FR)

(72) Inventors: Federico Camarda, Guyancourt (FR); Véronique Cherfaoui, Compiègne (FR); Franck Davoine, Compiègne (FR); Bruno Durand, Guyancourt (FR)

(73) Assignees: AMPERE S.A.S., Boulogne Billancourt (FR); CNRS, Paris (FR); UNIVERSITE DE TECHNOLOGIE DE COMPIEGNE (UTC), Compiègne (FR)

(21) Appl. No.: 18/701,299

(22) PCT Filed: Oct. 10, 2022
(86) PCT No.: PCT/EP2022/078053

§ 371 Date: Apr. 15, 2024

(30) Foreign Application Priority Data
Oct. 14, 2021 (FR) 2110938

(51) Int. Cl. G01C 21/36; B60W 30/12; G06V 20/56

(52) U.S. Cl. CPC G01C 21/3602; B60W 30/12; G06V 20/588

(57) ABSTRACT

The method (P1) for detecting a boundary (L1, L2, L3) of a traffic lane (VC1, VC2) for a motor vehicle (1) involves: (E1) detecting the boundary by a vehicle environment detection means (3), the boundary being defined by a function, in particular a polynomial function, (E4) determining a plurality of first vectors (MXi) characterizing the boundary on the basis of map data and on the basis of data on the current position and orientation of the vehicle, (E6) determining a plurality of second vectors (Fj) characterizing the boundary, each second vector being determined by an orthogonal projection of a first vector onto said function, and (E8) calculating Mahalanobis distances between each first vector and each second vector.

### TECHNICAL FIELD OF THE INVENTION

The invention relates to the field of methods for detecting boundaries of traffic lanes for motor vehicles. The invention also relates to the field of methods for determining the position of a vehicle on a road. The invention relates lastly to a motor vehicle equipped with means for implementing such methods.

### PRIOR ART

Traffic lane boundary detection plays an essential role in the development of autonomous vehicles. Correct detection is needed to construct an exact representation of the environment of the vehicle and to make appropriate decisions regarding control of the vehicle. In particular, a false detection of a traffic lane boundary, commonly referred to as a “false positive”, may have harmful consequences such as for example an incorrect orientation of the vehicle or an untimely braking maneuver.

Traffic lane boundaries may take many forms, such as painted lines on the ground, road surface boundaries, barriers, sidewalks, etc. These boundaries are therefore particularly complex to detect. To detect these boundaries, environment detection means such as cameras, radars or lidars are conventionally used. Although these detection means are becoming more and more sophisticated, the data that they provide sometimes contain uncertainties or errors. The complexity of the detection means, which are generally based on neural networks, makes it particularly difficult to understand or analyze false positives. Such defects limit the deployment of autonomous vehicles.

In order to improve traffic lane boundary detection, methods that consist in combining data received by environment detection means with map data are known. Document US20210004017A1 discloses one example of such a method. However, the known methods are still not efficient enough. In particular, they do not always make it possible to avoid the detection of false positives.

### PRESENTATION OF THE INVENTION

A first subject of the invention is a method for detecting a boundary of a traffic lane for a motor vehicle that makes it possible to avoid the detection of false positives.

A second subject of the invention is a detection method that makes it possible to improve the determination of the position of a vehicle on a given road.

### SUMMARY OF THE INVENTION

The invention relates to a method for detecting a boundary of a traffic lane for a motor vehicle, the method comprising:
a step of detecting said boundary, carried out by a detection means for detecting the environment of the vehicle, said detection means being housed on board the vehicle, the boundary detected by the detection means being defined by a function, in particular a polynomial function,
a step of determining a plurality of first vectors characterizing said boundary, the first vectors being determined on the basis of map data and on the basis of data regarding the current position and orientation of the vehicle,
a step of determining data relating to the uncertainty of each of the first vectors,
a step of determining a plurality of second vectors characterizing said boundary, each second vector being determined by an orthogonal projection of a first vector onto said function,
a step of determining data relating to the uncertainty of each of the second vectors,
a step of computing Mahalanobis distances between each first vector and each second vector resulting from the orthogonal projection of the first vector under consideration, each Mahalanobis distance being computed on the basis of the data relating to the uncertainty of each first vector and each second vector under consideration,
a step of classifying the boundary detected by the detection means as a true positive or as a false positive on the basis of the previously computed Mahalanobis distances.

The first vectors and the second vectors may be formulated in the same reference frame tied to the vehicle.

Each first vector may comprise:
a first component equal to a distance from an origin of the first vector under consideration to the vehicle, along a longitudinal axis of the vehicle,
a second component equal to a distance from the origin of the first vector under consideration to the vehicle, along a transverse axis of the vehicle,
a third component characterizing the orientation of a tangent to said boundary at the origin of the first vector,
   and each second vector may comprise:
a first component equal to a distance from an origin of the second vector under consideration to the vehicle, along a longitudinal axis of the vehicle,
a second component equal to a distance from the origin of the second vector under consideration to the vehicle, along a transverse axis of the vehicle,
a third component characterizing the orientation of a tangent to said boundary at the origin of the second vector.

Each first vector may be determined such that its origin is within a range of the detection means.

The data relating to the uncertainty of each of the first vectors may be computed on the basis of uncertainty values regarding the current positioning and orientation of the vehicle and on the basis of uncertainty values regarding the map data.

The data relating to the uncertainty of each of the second vectors may be computed by the detection means.

The detection method may comprise a step of computing the maximum Mahalanobis distance among the Mahalanobis distances computed between each first vector and each second vector resulting from the orthogonal projection of the first vector under consideration, the step of classifying the second traffic lane boundary as a true positive or as a false positive being carried out on the basis of the computed maximum Mahalanobis distance.

The invention also relates to a method for detecting a plurality of boundaries of traffic lanes for a motor vehicle, the method comprising:
a step of detecting a first set of traffic lane boundaries, carried out by a detection means for detecting the environment of the vehicle, said detection means being housed on board the vehicle,
a step of detecting a second set of traffic lane boundaries based on map data and on data regarding the current position and orientation of the vehicle,
a step of computing a matrix of Mahalanobis distances between each boundary of the first set and each boundary of the second set, each element of the matrix being equal to the maximum Mahalanobis distance computed by implementing the method for detecting a boundary as defined above with a boundary of the first set of boundaries and a boundary of the second set of boundaries,
a step of classifying the boundaries of the first set as a true positive or as a false positive by way of the matrix of Mahalanobis distances, by implementing a nearest neighbor determination algorithm on the matrix of Mahalanobis distances.

The method for detecting a plurality of boundaries may comprise a step of comparing a type of each boundary of the first set with a type of each boundary of the second set, and, in the step of computing the matrix of Mahalanobis distances, only elements of the matrix that satisfy a type comparison may be computed.

The invention also relates to a method for determining the position of a vehicle on a road, the method comprising:
a step of determining at least two positioning hypotheses for the vehicle,
   then, for each positioning hypothesis for the vehicle:
implementing the method for detecting a plurality of boundaries as defined above,
a step of computing a precision index on the basis of the number of true positives and false positives determined,
   then:
a step of selecting a positioning hypothesis by comparing between the precision indices computed for the various hypotheses.

The invention also relates to a computer program product comprising program code instructions recorded on a computer-readable medium for implementing the steps of the methods as defined above.

The invention also relates to a computer-readable data recording medium on which there is recorded a computer program comprising program code instructions for implementing the methods as defined above.

The invention also relates to a motor vehicle comprising a detection means for detecting the environment of the vehicle, a geolocation means for geolocating the vehicle, a determination means for determining the orientation of the vehicle, a memory or a means for accessing a memory in which map data are recorded, and a computing unit equipped with a data recording medium as defined above.

### PRESENTATION OF THE FIGURES

FIG. 1 is a schematic view of a motor vehicle according to one embodiment of the invention.

FIG. 2 is a first schematic plan view of the vehicle on a road comprising two traffic lanes, showing boundaries of a traffic lane as detected by a detection means housed on board the vehicle.

FIG. 3 is a block diagram of a method for detecting a boundary of a traffic lane according to one embodiment of the invention.

FIG. 4 is a second schematic plan view of the vehicle, showing boundaries of the traffic lane as determined by way of map data.

FIG. 5 is a third schematic plan view of the vehicle, showing, through vector modeling, the boundaries of the traffic lane as detected by the detection means housed on board the vehicle.

FIG. 6 is a block diagram of a method for detecting a plurality of traffic lane boundaries according to one embodiment of the invention.

FIG. 7 is a schematic plan view of the vehicle on a road comprising five traffic lanes.

FIG. 8 is a block diagram of a method for determining the position of a vehicle on a road according to one embodiment of the invention.

FIG. 9 is a graph showing the temporal evolution of a precision index computed for three positioning hypotheses for the vehicle.

### DETAILED DESCRIPTION

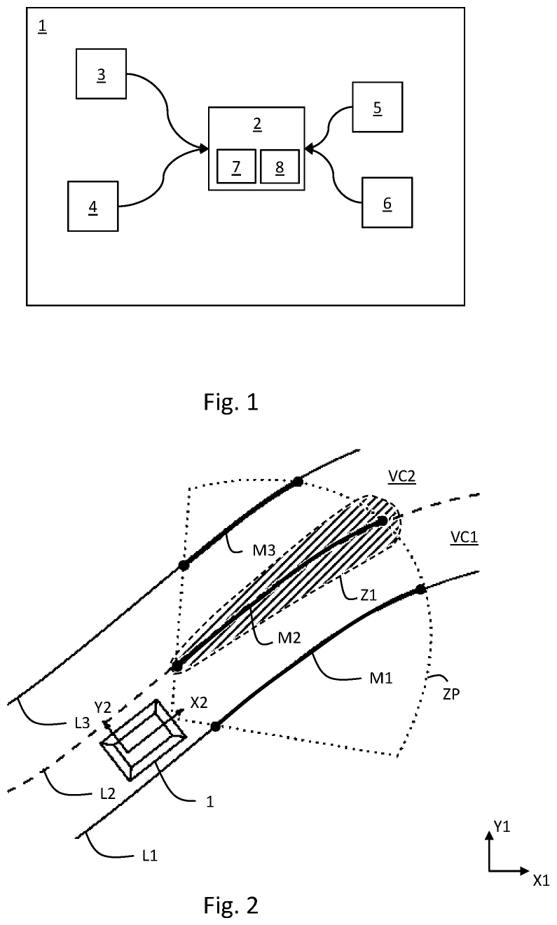

FIG. 1 schematically illustrates a motor vehicle 1 according to one embodiment of the invention. The vehicle 1 may be of any kind. In particular, it may be for example a private vehicle, a utility vehicle, a truck or a bus. The vehicle 1 comprises a computing unit 2, to which there are connected a detection means 3 for detecting the environment of the vehicle, a geolocation means 4, a determination means 5 for determining the orientation of the vehicle, and a memory 6 in which map data are recorded.

The detection means 3 may be for example a camera, a radar or a lidar. The detection means 3 may also be formed by the association of one or more cameras, radars or lidars. It is able to detect objects present in the environment of the vehicle, such as for example boundary lines painted on the ground, barriers, sidewalks or even any other form of boundary demarcating edges of a traffic lane. Advantageously, the detection means 3 is an intelligent detection means, that is to say it is able to interpret the signals that it perceives and to transmit data resulting from initial processing of these signals to the computing unit.

The geolocation means 4 is able to provide information regarding the geographical position of the vehicle 1, such as GPS coordinates. It may for example comprise a GPS sensor. The determination means 5 for determining the orientation of the vehicle is able to provide a datum relating to the orientation of the vehicle about an axis perpendicular to the plane on which the vehicle is resting. To simplify the description, it will be considered that the vehicle is resting on horizontal ground. The determination means 5 for determining the orientation of the vehicle is therefore able to provide a datum relating to the orientation of the vehicle about a vertical axis. The datum relating to the orientation of the vehicle may be equal to, or established on the basis of, a heading or azimuth followed by the vehicle. This datum may be provided for example by a GPS sensor, a gyroscope or else by a compass housed on board the vehicle.

The memory 6 is a data recording medium storing high-definition map data. These map data comprise positioning and orientation information regarding the boundaries of traffic lanes in a given territory. Each boundary of a traffic lane may in particular be stored in the form of a plurality of vectors, the composition of which will be described in detail below. The map data may in particular be presented in the form of the ADASISv3 standard. As a variant, the memory 6 could be outside the vehicle 1, the vehicle then comprising a means for accessing this memory, such as for example a 4 G or 5 G communication means. The memory 6 may also be integrated into the computing unit 2.

The computing unit 2 comprises in particular a memory 7 and a microprocessor 8. The memory 7 is a data recording medium on which there is recorded a computer program comprising program code instructions for implementing a boundary detection method according to one embodiment of the invention. The microprocessor 8 is able to execute said computer program.

The detection means 3, the location means 4 and the determination means 5 for determining the orientation of the vehicle are sensors housed on board the vehicle. They are able to provide information with a given uncertainty, or, in other words, with a given resolution. Similarly, the map data recorded in the memory 6 have a given uncertainty. The uncertainty therefore characterizes the precision of the information transmitted. These uncertainties are quantifiable. They may be presented in the form of a covariance matrix specific to each item of information provided by the various sensors, or specific to each map datum. Advantageously, and as will be explained below, these uncertainty values are utilized in the detection method to achieve better detection of said boundaries. It will be assumed hereinafter that the uncertainty associated with each item of information is unbiased and obeys a Gaussian law.

FIG. 2 shows the vehicle 1 on a road comprising two traffic lanes VC1 and VC2. The first traffic lane VC1 is delimited on either side by two boundaries L1 and L2. In this case, the two boundaries L1, L2 are a continuous line and a dashed line, respectively, both painted on the ground. As a variant, these two boundaries could be of a different type, such as for example a barrier, a sidewalk or a covering edge. The second traffic lane VC2 is adjacent to the first traffic lane VC1 and is delimited by the boundaries L2 and L3.

A first reference frame, referred to as global reference frame, which is fixed with respect to the traffic lanes and independent of the vehicle 1, is defined. This first reference frame is formed by the axes X1 and Y1. The axis X1 may for example be oriented along the North-South axis, and the axis Y1 may be oriented along the East-West axis. A second reference frame, referred to as vehicle reference frame, which is tied to the vehicle 1 and formed by the axes X2 and Y2, is also defined. The axis X2 corresponds to the longitudinal axis of the vehicle (that is to say the axis along which the vehicle moves in a straight line). The axis Y2 corresponds to the transverse axis of the vehicle and is perpendicular to the longitudinal axis X2.

The detection means 3 comprises a certain range, represented schematically by a dashed line ZP ahead of the vehicle. The range of the detection means is delimited in particular by a minimum longitudinal range Xmin and a maximum longitudinal range Xmax. In some cases, the minimum longitudinal range may be considered to be equal to zero. The maximum range Xmax may for example be of the order of a few tens of meters or a few hundred meters.

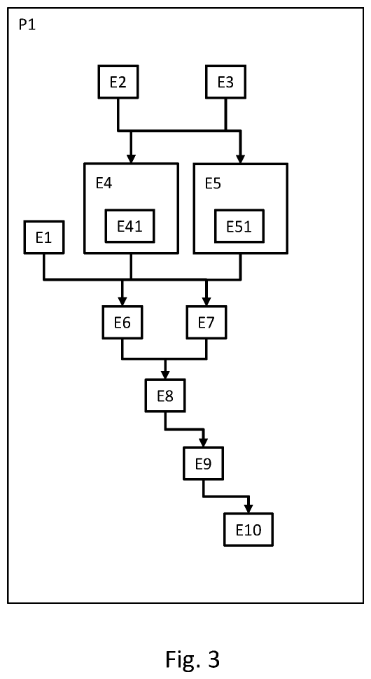

FIG. 3 is a block diagram illustrating the various steps of a method P1 for detecting a boundary of a traffic lane according to one embodiment of the invention. As will be seen hereinafter, this method may be implemented in order to detect any number of traffic lane boundaries. To simplify the description, an explanation is given first of all of the implementation of the detection method in order to detect a single boundary, for example the boundary L2 shown in FIG. 2.

The detection method aims to check whether the detection of a boundary carried out by the detection means 3 corresponds to a true positive (that is to say the detected boundary does actually exist) or to a false positive (that is to say the detected boundary results from an incorrect interpretation of the signals received by the detection means 3 and does not correspond to any real boundary). The various steps of one particular embodiment of this method will now be described.

In a first step E1, the detection means 3 detects the portion of a boundary within its range. It provides digital data characterizing the detected boundary to the computing unit 2 at a preset frequency. The boundary is characterized by a function of the type y=f(x) defined by the detection means 3. In particular, this function is a polynomial function, in particular a third-degree polynomial function. As a variant, the function could be a polynomial function of a different degree, or even any other mathematical function.

For each boundary Mi detected by the detection means 3, these digital data may be transmitted in the following form:

Mᵢ=[c₀, c₁, c₂, c₃, xₘᵢₙ, xₘₐₓ, ^{M}Σ_{P},M_{type}]

where:
c0, c1, c2 and c3 are the coefficients of the third-degree polynomial function P(x)
Xmin and Xmax are the minimum and maximum longitudinal range of the detection means 3,
MΣP is a covariance matrix representing the uncertainty regarding detection of the boundary L2 performed by the detection means 3, and
Mtype is a datum representative of the nature or type of boundary detected (which may include for example painted lines on the ground, barriers, sidewalks, etc.).

Each boundary is thus defined in the vehicle reference frame by a curve y=P(x), with:

$$P ( x ) = {c}_{0} + {c}_{1} x + {c}_{2} {x}^{2} + {c}_{3} {x}^{3}$$

The polynomial function P(x) characterizes the shape of the boundary under consideration. This function is definite for any value of x between Xmin and Xmax. At a given instant, a boundary detected by the detection means 3 is therefore characterized by four coefficients of a polynomial function. Such a way of representing a boundary makes it possible to reduce the amount of data exchanged between the detection means 3 and the computing unit 2 compared to a model in which all points belonging to a boundary would be transmitted to the computing unit 2.

The covariance matrix MΣP may be expressed in the following form:

$${}^{M} {\sum }_{P} = [ \begin{matrix}{σ}_{xx}^{2} & & & 0 & 0 \\ & {σ}_{{c}_{0} {c}_{0}}^{2} & & & 0 \\ & & {σ}_{{c}_{1} {c}_{1}}^{2} & & \\ 0 & & & {σ}_{{c}_{2} {c}_{2}}^{2} & \\ 0 & 0 & & & {σ}_{{c}_{3} {c}_{3}}^{2}\end{matrix} ]$$

where σxx, σc0c0, σc1c1, σc2c2, σc3c3 are standard deviation parameters.

FIG. 2 uses three curved lines M1, M2 and M3 to represent the representation of each of the boundaries L1, L2 and L3 as computed by the detection means 3. For the line M2, a zone Z1 has been used to schematically represent the uncertainty associated with the detection of the boundary L2. The zone Z1 indicates a zone within which the boundary L2 is probably located. When the boundary L2 is recognized well by the detection means 3 (for example when the painted line on the ground exhibits good contrast and visibility is good), the zone Z1 may be particularly constricted around the line M2. On the contrary, when the boundary L2 is recognized poorly by the detection means 3 (for example when the painted line on the ground exhibits poor contrast and/or when visibility is poor), the zone Z1 may be particularly wide around the line M2. Of course, such zones could also be represented for the lines M1 and M3.

In a second step E2, the geolocation means 4 and the determination means 5 for determining the orientation of the vehicle respectively determine the current position and orientation of the vehicle 1, in the global reference frame. They provide digital data to the computing unit 2 at a preset frequency. These digital data may be represented in the following form:

$${}^{O} {X}_{M} = [ \begin{matrix}{}^{O} {x}_{M} \\ {}^{O} {y}_{M} \\ {}^{O} {θ}_{M}\end{matrix} ]$$

where:
OxM designates the position of the vehicle along the axis X1 in the global reference frame,
OyM designates the position of the vehicle along the axis Y1 in the global reference frame, and
OθM designates the orientation of the vehicle in the global reference frame.

In a third step E3, the measurement uncertainty of the geolocation means 4 and of the determination means 5 for determining the orientation of the vehicle is determined. This uncertainty may be quantified by the geolocation means 4 and the determination means 5 for determining the orientation of the vehicle and transmitted to the computing unit 2. This uncertainty may for example depend on the quality of the GPS signal received by the geolocation means 4, or on any other factor likely to influence the operation of the geolocation means 4 and/or of the determination means 5 for determining the orientation of the vehicle. As a variant, this uncertainty could also be computed by the computing unit 2 or be set to a predetermined value. This uncertainty may be expressed in the form of a covariance matrix OΣM of dimension 3×3, the form of which is as follows:

$${}^{O} {\sum }_{M} = Var ( [ \begin{matrix}{}^{O} {x}_{M} \\ {}^{O} {y}_{M} \\ {}^{O} {θ}_{M}\end{matrix} ] )$$

In a fourth step E4, a plurality of first vectors MXi characteristic of a boundary are determined based on map data and based on data regarding the current position and orientation of the vehicle. Advantageously, the set of first vectors MXi that are determined is circumscribed in a given perimeter around the vehicle. This perimeter, also called e-horizon or electronic horizon, may correspond to the range of the detection means 3. It will therefore be understood that the first vectors come from the map database and are circumscribed in a zone defined by the current position and orientation of the vehicle.

In a fifth step E5, data relating to the uncertainty of each of the first vectors MXi are determined.

More precisely, the memory 6 provides the computing unit 2 with digital data regarding the various boundaries present within a given perimeter around the vehicle. The memory 6 containing the map data may be seen as a sensor housed on board the vehicle and providing information with a given precision. Each boundary is defined by a set of first vectors MXi. The map data therefore provide discrete information for defining each of the boundaries. Each boundary MLI present within a perimeter around the vehicle may be defined in the following form:

$${}^{M} {L}_{l} = {[}^{M} {X}_{i = 1 . . {N}_{i}} , Var {(}^{O} {X}_{i = 1 . . {N}_{i}} ) , {L}_{type} ]$$

where:
MXi=1. . . Ni designates the set of first vectors expressed in the vehicle reference frame and belonging to the boundary MLI,
Var(OXi=1. . . Ni) designates a set of covariance matrices Var(OXi) expressed in the global reference frame, the covariance matrices Var(OXi) representing the uncertainty associated with the position and orientation of each of the vectors MXi, and
Ltype is a datum representative of the nature or type of boundary detected.

Each of the first vectors MXi may be expressed, in the vehicle reference frame, in the following form:

$${}^{M} {X}_{i} = [ \begin{matrix}{}^{M} {x}_{i} \\ {}^{M} {y}_{i} \\ {}^{M} {h}_{i}\end{matrix} ]$$

where:
Mxi designates the coordinate, along the axis X2, of the origin of the vector MXi. This is the distance to the vehicle from a given point of a boundary as defined by the map data, along the longitudinal axis X2 of the vehicle,
Myi designates the coordinate, along the axis Y2, of the origin of the vector MXi. This is the distance to the vehicle from the given point along the transverse axis Y2 of the vehicle, and
Mhi designates the orientation of the vector MXi in the vehicle reference frame. It characterizes the orientation of the tangent to the boundary under consideration at the given point.

Each covariance matrix Var(OXi) of the set of covariance matrices Var(OXi=1. . . Ni) is a matrix of dimension 3×3 and may be expressed in the following form:

$$Var ( {}^{O} {X}_{i} ) = Var ( [ \begin{matrix}{}^{O} {x}_{i} \\ {}^{O} {y}_{i} \\ {}^{O} {h}_{i}\end{matrix} ] )$$

These matrices represent the uncertainty associated with the map data for each vector MXi. This uncertainty may stem from the means used to develop the map data. The data characterizing the uncertainty of the map data are also stored in the memory 6.

Advantageously, the first vectors MXi are formulated in the vehicle reference frame, and the covariance matrices Var(OXi) characterizing the uncertainty of the first vectors MXi are formulated in the global reference frame. Since the map data initially available in the memory 6 are formulated in the global reference frame, the fourth step E4 advantageously comprises a sub-step E41 of computing the first vectors in the vehicle reference frame on the basis of the first vectors expressed in the global reference frame. In this sub-step, each first vector MXi is computed on the basis of the data regarding the position and orientation of the vehicle that were determined in step E2. In particular, the following formula may be used:

$${}^{M} {X}_{i} = [ \begin{matrix}{}^{M} {x}_{i} \\ {}^{M} {y}_{i} \\ {}^{M} {h}_{i}\end{matrix} ] = [ {}^{M} {R}_{O} \begin{matrix}( [ \begin{matrix}{}^{O} {x}_{i} \\ {}^{O} {y}_{i}\end{matrix} ] - [ \begin{matrix}{}^{O} {x}_{m} \\ {}^{O} {y}_{m}\end{matrix} ] ) \\ {}^{O} {h}_{i} - {}^{O} {θ}_{M}\end{matrix} ]$$

where:
MRo designates a rotation matrix,
Oxi designates the coordinate, along the axis X1, of the origin of the vector MXi expressed in the global reference frame,
Oyi designates the coordinate, along the axis Y1, of the origin of the vector MXi expressed in the global reference frame, and
Ohi designates the orientation of the vector MXi expressed in the global reference frame.

The rotation matrix MRo may be expressed as follows:

$${}^{M} {R}_{O} = {}^{O} {R}_{M}^{T} = [ \begin{matrix}cos ( θ ) & sin ( θ ) \\ - sin ( θ ) & cos ( θ )\end{matrix} ]$$

where θ=OθM and designates the orientation of the vehicle in the global reference frame.

Similarly, the fifth step E5 comprises a sub-step E51 of computing the set of covariance matrices Var(OXi) in the vehicle reference frame. This computing may be carried out using the following formula:

$$Var {(}^{M} {X}_{i} ) = {[ \frac{{\partial }^{M} {X}_{i}}{{\partial }^{O} {X}_{6}} ] [ \begin{matrix}{}^{O} {\sum }_{M} & 0 \\ 0 & Var {(}^{O} {X}_{i} )\end{matrix} ] [ \frac{{\partial }^{M} {X}_{i}}{{\partial }^{O} {X}_{6}} ]}^{T}$$

where:
Var(MXi) designates a covariance matrix characterizing the uncertainty associated with the position and orientation of the vector MXi, in the vehicle reference frame,
δMXi/δOX6 designates a Jacobian matrix, which is defined below,
OΣM is the covariance matrix characterizing the measurement uncertainty of the geolocation means 4 and of the determination means 5 for determining the orientation of the vehicle, as defined above, and
Var(Oxi) designates the covariance matrix representing the uncertainty associated with the position and orientation of the vector MXi, in the global reference frame.

The Jacobian matrix δMXi/δOX6 may be defined by the following formula:

$$[ \frac{{\partial }^{M} {X}_{i}}{{\partial }^{O} {X}_{6}} ] = [ \begin{matrix}- cos ( θ ) & - sin ( θ ) & {}^{M} {y}_{i} & cos ( θ ) & sin ( θ ) & 0 \\ sin ( θ ) & - cos ( θ ) & - {}^{M} {x}_{i} & - sin ( θ ) & cos ( θ ) & 0 \\ 0 & 0 & - 1 & 0 & 0 & 1\end{matrix} ]$$

where:
θ=OθM and designates the orientation of the vehicle in the global reference frame,
Mxi designates the coordinate, along the axis X2, of the origin of the vector MXi expressed in the vehicle reference frame, and
Myi designates the coordinate, along the axis Y2, of the origin of the vector MXi expressed in the vehicle reference frame.

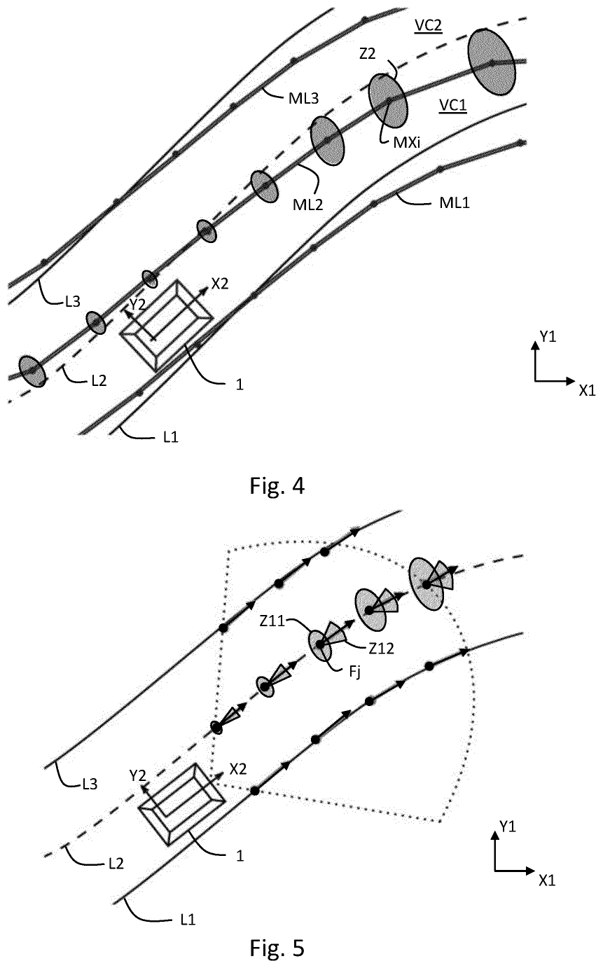

Ultimately, at this stage of the detection method, a vector model of a boundary based on map data is available, on the one hand. The boundary is characterized by a set of first vectors MXi expressed in the vehicle reference frame. Data characterizing the uncertainty of this set of first vectors are also available. This uncertainty is also expressed in the vehicle reference frame. FIG. 4 schematically illustrates the boundaries ML1, ML2 and ML3 resulting from the map data and defined by implementing the fourth step E4 for each of the boundaries L1, L2 and L3. The origin of each vector MXi is identified by a point belonging to the boundaries ML1, ML2 and ML3. In particular, for each vector MXi characterizing the boundary L2, zones Z2 have been used to represent the uncertainty regarding the position of the origin of the vectors MXi. Modeling boundaries using map data is a form of discrete modeling, that is to say the boundaries are defined by a finite set of vectors. A continuous model of the boundaries, produced by the detection means 3, is available, on the other hand. Indeed, since the boundaries are expressed in the form of a function of the type y=f(x), they are definite at any point within the range of the detection means 3. To compare these two models, the continuous model of the boundaries from the detection means 3 is discretized.

In a sixth step E6, a plurality of second vectors Fj characteristic of the boundary as identified by the detection means 3 are determined. Each second vector Fj is determined by an orthogonal projection of a vector MXi from the set of first vectors onto the function y=P(x) defined above. In other words, each second vector Fj is determined such that its origin belongs to the function y=P(x), and such that the straight line passing through the origin of the vector Fj and through the origin of the vector MXi is perpendicular to the function y=P(x), and such that the orientation of the vector Fj is equal to the orientation of a tangent to the function y=P(x) at the origin of the vector Fj. It should be noted that the function y=P(x) generally has radii of curvature that are large enough for there to be a single orthogonal projection of the vector MXi onto the function y=P(x). In the very rare hypothesis where there might be multiple possible orthogonal projections of the vector MXi onto the function y=P(x), one of these projections, for example the first projection that is found, may be used arbitrarily, that is to say the search for an orthogonal projection would be stopped as soon as one is found.

The model of the boundary as detected by the detection means 3 is thus discretized. Discretizing this model involves representing each boundary not by a function (which is definite at any point between Xmin and Xmax), but by a finite set of vectors Fj. Each vector Fj locally characterizes a boundary with the coordinates of a point of the boundary in the vehicle reference frame and a component characterizing the orientation of the boundary under consideration at this point. For a given boundary, the vector Fj may therefore be expressed as follows in the vehicle reference frame:

$${F}_{j} = [ \begin{matrix}{x}_{j} \\ P ( {x}_{j} ) \\ arctan ( {P}^{′} ( {x}_{j} ) )\end{matrix} ] = [ \begin{matrix}{x}_{j} \\ {c}_{0} + {c}_{1} {x}_{j} + {c}_{2} {x}_{j}^{2} + {c}_{3} {x}_{j}^{3} \\ arctan ( {c}_{1} + 2 {c}_{2} {x}_{j} + 3 {c}_{3} {x}_{j}^{2} )\end{matrix} ]$$

where:
xj designates the coordinate, along the axis X2, of a given point of a boundary detected by the detection means 3. This is therefore the distance from the given point to the vehicle along the longitudinal axis X2 of the vehicle.
P(xj) designates the coordinate, along the axis Y2, of the given point. This is therefore the distance from the given point to the vehicle along the transverse axis Y2 of the vehicle.
arctan (P′(xj)) designates the arc-tangent function of the derivative of the function P(x) at the point under consideration. This component characterizes the orientation of the tangent to the curve y=P(x) at the point under consideration.

FIG. 5 shows one example of a discretization of the lines M1, M2 and M3. Each line M1, M2 or M3 is represented by a set of vectors Fj the origin of which is a point of coordinates (x(j), P(x(j)) in the vehicle reference frame and the orientation of which is equal to arctan (P′(xj)).

In a seventh step E7, the uncertainty associated with each of the second vectors Fj is determined. Indeed, the uncertainty of the detection means 3 with regard to the detection of each of the boundaries may also be discretized. For each vector F(j), the measurement uncertainty may be computed using the following formula:

$${}^{M} {\sum }_{F} = Var ( [ \begin{matrix}{x}_{j} \\ {y}_{j} \\ {θ}_{j}\end{matrix} ] ) = [ \frac{\partial {F}_{j}}{\partial {M}_{i}} ] {{}^{M} {\sum }_{P} [ \frac{\partial {F}_{j}}{\partial {M}_{i}} ]}^{T}$$

where:
mΣF designates a covariance matrix of dimension 3×3,
yj=P(xj),
θj=arctan(P′(xj)),
δFj/δMi designates a partial derivative of the vector Fj, in particular the Jacobian matrix of the vector Fj, a function of the variables xj, c0, c1, c2, c3 and
MΣP is the covariance matrix representing the measurement uncertainty of the detection means 3, described above.

In FIG. 5, for each vector Fj characterizing the boundary L2, zones Z11 have been used to represent the uncertainty regarding the position of the origin of the vectors Fj, and zones Z12 have been used to represent the uncertainty regarding the orientation of the vectors Fj. Owing to the uncertainty regarding the orientation of the vehicle, the uncertainty regarding the vectors Fj furthest from the vehicle is greater. The zones Z11 and Z12 are therefore larger when moving away from the vehicle.

In an eighth step E8, the Mahalanobis distances between each first vector MXi and each second vector Fj resulting from the orthogonal projection of the first vector MXi under consideration are computed. The computing of a Mahalanobis distance is based not only on the components of the vectors MXi and Fj, but also on the data relating to the uncertainty of these two vectors. The Mahalanobis distance between the vectors Fj and MXi may be computed using the following formula:

$$d ( MXi , Fj ) = \sqrt{{( MXi - Fj )}^{T} {( M \sum F + Var ( MXi ) )}^{- 1} ( MXi - Fj )}$$

where:
MXi designates a vector from the set of first vectors,
Fj designates the vector of the set of second vectors resulting from the orthogonal projection of the first vector MXi onto the function y=P(x),
mΣF is the covariance matrix characterizing the uncertainty of the vector Fj,
Var(MXi) is the covariance matrix characterizing the uncertainty of the vector MXi.

The Mahalanobis distance thus computed is a value representative of the similarity between the vector Fj and the vector MXi. This Mahalanobis distance may be computed for each vector MXi the origin of which is within range of the detection means 3.

In a ninth step E9, the maximum Mahalanobis distance among the Mahalanobis distances computed between each first vector of one and the same boundary and each second vector associated with the first vector under consideration is computed. This maximum value is an indicator of the similarity between a boundary as detected by the detection means 3 and a boundary as identified in the map data. The lower the maximum value, the closer the boundary as detected by the detection means 3 will be considered to be to the boundary as identified in the map data. The Mahalanobis distance between a boundary as detected by the detection means 3 and a boundary as identified in the map data may be defined as equal to this maximum value.

In a tenth step E10, the boundary of the traffic lane as detected by the detection means 3 is classified as a true positive or as a false positive on the basis of the maximum distance computed in step E9. To this end, it is possible for example to compare the previously computed maximum value with a predefined threshold, determined in a calibration phase of the method.

As a variant, the classification of the boundary of the traffic lane as detected by the detection means 3 as a true positive or as a false positive could be based on other indicators, which are themselves based on the set of previously computed Mahalanobis distances. For example, a mean value or a minimum value of the set of Mahalanobis distances computed between the vectors MXi and Fj could be compared with a threshold. However, a comparison of the maximum value is easy to implement and allows reliable classification as a true positive or as a false positive.

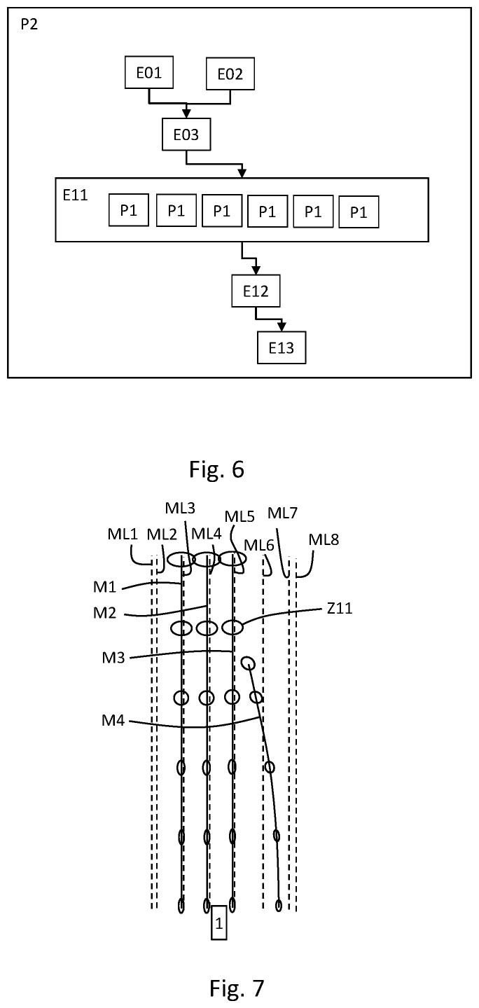

With reference to FIG. 6, a description is now given of one embodiment of a method P2 for detecting a plurality of traffic lane boundaries. The method P2 comprises a step E01 of detecting a first set of traffic lane boundaries based on data provided by a detection means of the vehicle, and a step E02 of detecting a second set of traffic lane boundaries based on map data and on data regarding the current position and orientation of the vehicle. Steps E01 and E02 are executed prior to the implementation of the method P1 as described above.

According to a first variant embodiment of the invention, the method P1 as defined by steps E1 to E10 may be executed for each possible pair formed by a boundary of the first set and by a boundary of the second set. If there is a number N1 of boundaries detected by the detection means 3 and a number M1 of boundaries identified in the map data, the method P1 is repeated a number of times equal to N1×M1. Such a variant may require a particularly large amount of computing resources.

According to a second, more advantageous variant embodiment of the invention, the detection method may comprise a step E03 of comparing a type of boundary detected by the detection means 3 with a type of boundary identified in the map data. The method is then implemented only in order to compute the Mahalanobis distance between boundaries of the same type, and possibly between a boundary of any type and a boundary of unknown type. For example, the detection means may detect three boundaries M1, M2 and M3 of the type “painted line on the ground”, of unknown type and of barrier type, respectively. At the same time, the map data may identify three boundaries ML1, ML2 and ML3 of the type “painted line on the ground”, of unknown type and of “barrier” type, respectively. In this case, the method will be used to compute the Mahalanobis distance between the following pairs of boundaries:
M1, ML1
M1, ML2
M2, ML1
M2, ML2
M2, ML3
M3, ML2
M3, ML3

The method will not be used to compute the Mahalanobis distance between the following pairs of boundaries:
M1, ML3
M3, ML1

Implementing this comparison step therefore makes it possible to reduce the number of computing operations executed by the computing unit 2.

Next, in an eleventh step E11, the method P1 as defined by steps E1 to E10 is implemented for each identified pair of boundaries and leads to the determination of a maximum Mahalanobis distance for each of these pairs. Next, in a twelfth step E12, a matrix of Mahalanobis distances between each boundary of the first set and each boundary of the second set is computed, each element of the matrix being equal to the maximum Mahalanobis distance computed by implementing the method P1 with a boundary of the first set of boundaries and a boundary of the second set of boundaries. Of course, assuming that step E03 of comparing the types of boundaries is performed beforehand, only elements of the matrix that satisfy the type comparison as explained above are computed.

Next, in a thirteenth step E13, the boundaries of the second set are classified as a true positive or as a false positive by way of the matrix of Mahalanobis distances, by implementing a nearest neighbor determination algorithm on the matrix of Mahalanobis distances. Such an algorithm is also commonly referred to as a “Global Nearest Neighbor (GNN)” algorithm. It makes it possible to obtain the best possible association between a boundary of the second set and a boundary of the first set.

If it is impossible to associate a boundary of the first set with a boundary of the second set, it is possible to deduce therefrom that the boundary of the first set corresponds to a false positive, that is to say it results from a false detection carried out by the detection means 3.

FIG. 7 illustrates the results of implementing the method P2 on a road comprising five parallel traffic lanes. The vehicle 1 is positioned on the central traffic lane. The detection means 3 detects four boundaries M1, M2, M3 and M4, represented by solid lines in FIG. 7. Three boundaries M1, M2 and M3 are straight, while the fourth boundary M4 is curved. For each boundary, a circle or an oval has been used to represent the zones Z11 representing the uncertainties regarding the position of the origin of the vectors Fj. Moreover, the map data are used to identify eight boundaries ML1 to ML8, represented by dashed lines in FIG. 7. A method P2 for detecting a plurality of traffic lane boundaries is then implemented. Following the execution of the nearest neighbor determination algorithm, the boundaries M1, M2 and M3 are then associated with the boundaries ML3, ML4 and ML5, respectively. None of the boundaries defined by the map data is able to be associated with the boundary M4. The latter is then correctly classified as a false positive.

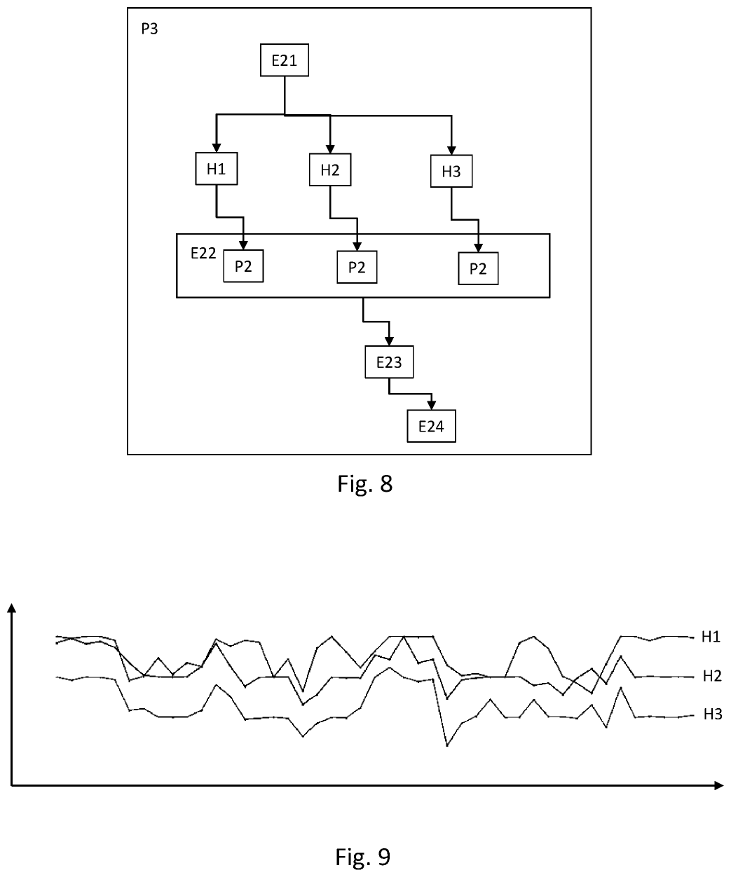

The method for detecting a plurality of traffic lane boundaries may also be used in a method P3 for determining the position of a vehicle on a road. One embodiment of such a method is illustrated in FIG. 8.

In a first step E21, at least two positioning hypotheses for the vehicle are determined. For example, if it is assumed that the vehicle 1 is on a road, such as a freeway, comprising three parallel traffic lanes, a first hypothesis H1 consists in assuming that the vehicle 1 is positioned on the rightmost traffic lane. A second hypothesis H2 consists in assuming that the vehicle 1 is positioned on the central traffic lane. A third hypothesis H3 consists in assuming that the vehicle 1 is positioned on the leftmost traffic lane.

Next, in a second step E22, the above-described method P2 for detecting a plurality of traffic lane boundaries is implemented for each positioning hypothesis H1, H2, H3 for the vehicle. In successive implementations of the method P2, the current position of the vehicle as determined by the geolocation means 4 is modified so as to position the vehicle in accordance with each of the positioning hypotheses. In this case, the determined current position of the vehicle is corrected so as to position the vehicle successively in the center of the right-hand traffic lane, then in the center of the central lane, and then in the center of the left-hand traffic lane. This correction may be made by applying an offset to the component Myi, corresponding to the coordinate, along the axis Y2, of the origin of each vector MXi.

Next, in a third step E23, a precision index is computed on the basis of the number of true positives and false positives determined for each hypothesis H1, H2, H3. For example, the precision index may be computed using the following formula:

$$Precision ( t , t + 5 ) = \frac{TP}{TP + FP}$$

where:
Precision (t, t+5) designates the precision index computed over a time window of five seconds,
TP designates the number of true positives computed over the time window of five seconds, and
FP designates the number of false positives computed over the time window of five seconds.

FIG. 9 shows the evolution of the precision index for each of the hypotheses H1, H2 and H3. It is observed that the precision index associated with the hypothesis H1 is higher overall than the precision index associated with the hypothesis H2, which is itself higher overall than the precision index associated with the hypothesis H3. It is thus possible to discriminate between the various hypotheses. Thus, in a fourth step E24, a positioning hypothesis is selected by comparing between the precision indices computed for the various hypotheses. For this purpose, it is possible for example to retain the hypothesis the precision index of which has the highest mean value over a given time window, that is to say the hypothesis H1 according to the example of FIG. 9. It is thus possible to determine the lane in which the vehicle is actually traveling. This information may be utilized in vehicle autonomous control systems or else in navigation systems.

The invention provides a method for detecting one or more boundaries of a traffic lane that makes it possible to identify the detection of false positives by the detection means for detecting the environment that is housed on board the vehicle. This detection method may advantageously be implemented in a method for determining the position of a vehicle on a road in order to determine the position of the vehicle with greater reliability.

It should be noted that enumerating terms such as first, second, etc. are intended solely to distinguish between the various steps of the method. These terms do not characterize any order relationship between the various steps, which may be performed in any order provided that the data needed at input are available. The block diagrams shown in FIGS. 3, 6 and 8 use arrows to indicate one possible order between the various steps. However, a different order could be envisaged by those skilled in the art in order to achieve the same results. The described methods may be repeated indefinitely at a predefined iteration frequency.

1. A method for detecting a boundary of a traffic lane for a motor vehicle, wherein the method comprises:
detecting the boundary, carried out by detecting an environment of the vehicle from on board of the vehicle, the detected boundary being defined by a function,
determining a plurality of first vectors characterizing the boundary, the first vectors being determined based on map data and based on data regarding a current position and a current orientation of the vehicle,
determining data relating to an uncertainty of each of the first vectors,
determining a plurality of second vectors characterizing the boundary, each of the second vectors being determined by an orthogonal projection of a respective one of the first vectors onto the function,
determining data relating to an uncertainty of each of the second vectors,
computing Mahalanobis distances between each of the first vectors and the respective second vector resulting from the orthogonal projection of each respective first vector, each of the respective Mahalanobis distances being computed based on the data relating to the uncertainty of the respective first vector and the respective second vector, and
classifying the detected boundary as a true positive or as a false positive based on the computed Mahalanobis distances.

2. The detection method as claimed in claim 1, wherein the first vectors and the second vectors are formulated in a same reference frame tied to the vehicle.

3. The detection method as claimed in claim 1,
wherein each of the first vectors comprises:
a first component equal to a distance from an origin of the respective first vector to the vehicle, along a longitudinal axis of the vehicle,
a second component equal to a distance from the origin of the respective first vector to the vehicle, along a transverse axis of the vehicle, and
a third component characterizing an orientation of a tangent to the boundary at the origin of the respective first vector,
and wherein each of the second vectors comprises:
a first component equal to a distance from an origin of the respective second vector to the vehicle, along a longitudinal axis of the vehicle,
a second component equal to a distance from the origin of the respective second vector to the vehicle, along a transverse axis of the vehicle, and
a third component characterizing an orientation of a tangent to the boundary at the origin of the respective second vector.

4. The detection method as claimed in claim 1, wherein each of the first vectors is determined so that an origin of the respective first vector is within a range of detection from on board the vehicle.

5. The detection method as claimed in claim 1, wherein the data relating to the uncertainty of each of the first vectors are computed based on uncertainty values regarding the current positioning and the current orientation of the vehicle and based on uncertainty values regarding the map data.

6. The detection method as claimed in claim 1, wherein:
the method comprises computing a maximum Mahalanobis distance among the Mahalanobis distances computed between each of the first vectors and the respective second vector resulting from the orthogonal projection of the respective first vector, and
the classifying of the second traffic lane boundary as a true positive or as a false positive is carried out based on the computed maximum Mahalanobis distance.

7. A method for detecting a plurality of boundaries of traffic lanes for a motor vehicle, wherein the method comprises:
detecting a first set of traffic lane boundaries, carried out by detecting an environment of the vehicle from on board the vehicle,
detecting a second set of traffic lane boundaries based on map data and on data regarding the current position and the current orientation of the vehicle,
computing a matrix of Mahalanobis distances between each of the boundaries of the first set and each of the boundaries of the second set,
wherein each element of the matrix being equal to the maximum Mahalanobis distance computed by implementing the detection method as claimed in claim 6 with a boundary of the first set of and a boundary of the second set, and
classifying the boundaries of the first set as a true positive or as a false positive by way of the matrix of Mahalanobis distances, by implementing a nearest neighbor determination algorithm on the matrix of Mahalanobis distances.

8. The detection method as claimed in claim 7, wherein:
the method comprises comparing a type of each of the boundaries of the first set with a type of each of the boundaries of the second set, and
in the computing of the matrix of Mahalanobis distances, only elements of the matrix that satisfy a type comparison are computed.

9. A method for determining the position of a vehicle on a road, wherein the method comprises:
determining at least two positioning hypotheses for the vehicle,
then, for each positioning hypothesis for the vehicle:
implementing the detection method as claimed in claim 7,
computing a precision index based on a number of true positives and false positives determined,
then:
selecting a positioning hypothesis by comparing between the precision indices computed for the various hypotheses.

10. A non-transitory computer-readable medium comprising program code instructions for implementing the method as claimed in claim 1 when the program runs on a computer.

11. A computer program product comprising the non-transitory computer-readable data recording medium as claimed in claim 9.

12. A motor vehicle, comprising:
a detection means for detecting an environment of the vehicle,
a geolocation means for geolocating the vehicle,
a determination means for determining an orientation of the vehicle,
a memory or a means for accessing a memory in which map data are recorded, and
a computing unit equipped with a computer program product as claimed in claim 11.

13. The detection method as claimed in claim 1, wherein the function is a polynomial function.

14. The detection method as claimed in claim 1, wherein the detecting of the boundary is carried out by detection means housed on board of the vehicle.

15. The detection method as claimed in claim 14, wherein each of the first vectors is determined so that an origin of the respective first vector is within a range of the detection means.

16. The detection method as claimed in claim 14, wherein the data relating to the uncertainty of each of the second vectors are computed by the detection means.

17. The method as claimed in claim 7, wherein the detecting of the first set of boundaries is carried out by detection means housed on board of the vehicle.

18. A method for determining the position of a vehicle on a road, wherein the method comprises:
determining at least two positioning hypotheses for the vehicle, then, for each positioning hypothesis for the vehicle:
implementing the detection method as claimed in claim 8,
computing a precision index based on a number of true positives and false positives determined,
then:
selecting a positioning hypothesis by comparing between the precision indices computed for the various hypotheses.

19. A non-transitory computer-readable medium comprising program code instructions for implementing the method as claimed in claim 7 when the program runs on a computer.

20. A non-transitory computer-readable medium comprising program code instructions for implementing the method as claimed in claim 9 when the program runs on a computer.
